(19) United States
(12) Patent Application Publication
(10) Pub. No.: US 2025/0002759 A1
(43) Pub. Date: Jan. 2, 2025

(54) HIGH TEMPERATURE DURABLE PRESSURE SENSITIVE ADHESIVES

(71) Applicant: 3M INNOVATIVE PROPERTIES COMPANY, St. Paul, MN (US)

(72) Inventors: Encai Hao, Woodbury, MN (US); Jason D. Clapper, Lino Lakes, MN (US); Michelle L. Toy, North St. Paul, MN (US)

(21) Appl. No.: 18/708,906

(22) PCT Filed: Oct. 31, 2022
(86) PCT No.: PCT/IB2022/060480

§ 371 Date: May 9, 2024

Related U.S. Application Data
(60) Provisional application No. 63/264,047, filed on Nov. 15, 2021.

(51) Int. Cl. C09J 7/38; B32B 7/12

(52) U.S. Cl. CPC C09J 7/385; B32B 7/12; B32B 2255/26; B32B 2307/412; B32B 2307/42; B32B 2457/20; C09J 2301/302; C09J 2301/312

(57) ABSTRACT

The present invention is a pressure sensitive adhesive including the reactive product of a copolymer of an alkyl(meth)acrylate, a multifunctional cross-linker, and at least one of an amine-containing (meth)acrylate and a blocked isocyanate-containing (meth)acrylate.

### FIELD OF THE INVENTION

The present invention is related generally to the field of pressure sensitive adhesives. In particular, the present invention is a pressure sensitive adhesive that is durable at high temperatures.

### BACKGROUND

Pressure-sensitive adhesives (PSAs) are known and commonly used in the electronics and display industries. Some pressure-sensitive adhesives are formulations based on acrylates, natural rubbers, synthetic rubbers, vinyl acetates, and silicones. Acrylate PSAs are of particular utility in that they are relatively low in cost, adhere well to a variety of different surfaces, and can be formulated to build adhesion to a surface. However, high temperature performance of acry late PSAs can pose challenges. Examples of such acry late PSAs are disclosed in U.S. Pat. No. Re 24,906 (Ulrich).

Optically clear adhesives (optical grade PSAs, hereinafter referred to as “OCAs”) are widely used to bond constituent components of optical laminates such as touch panels. For example, bonding a surface protection material (e.g., a cover lens) to a touch panel module. Display units provided with touch panels can be used in a variety of environmental conditions, such as high temperature and/or high humidity depending on the intended use of the display unit. In addition to maintaining high transparency under such environmental conditions, OCAs need to exhibit characteristics such as heat resistance and resistance to moist heat. These characteristics can be evaluated by investigating whether or not bubbling, peeling, clouding, white opacity or the like occurs in an optical laminate when the optical laminate that contains an OCA is subjected to an accelerated aging test under conditions of high temperature/high humidity.

Bubbling and peeling, which can occur in optical laminates, can be caused by outgas produced from materials that constitute optical laminates, differences in coefficient of thermal expansion between constituent materials, and the like. For example, plastic films used as cover lenses for touch panel modules, such as poly(methyl methacry late) (PMMA) or polycarbonates (PC) can produce outgas under high temperature conditions, thereby leading to bubbling or peeling between these films and a touch panel module. Meanwhile, under moist heat conditions, moisture vapor from the environment can penetrate from the sides of a touch panel, pass through these films or condense inside a touch panel when the touch panel is cooled, thereby causing clouding or white opacity inside the touch panel.

In a variety of display applications, optical stacks that include an absorbing polarizer and an optically clear adhesive and/or a reflective polarizer are very useful. For example, the inner polarizer (the polarizer facing away from the viewer) in a liquid crystal display (LCD) may include an optical stack that includes a reflective polarizer facing the backlight and an absorbing polarizer facing the display panel. Polarizer stacks and their use in display applications are generally described in U.S. Pat. No. 6,025,897 (Weber et al.). The reflective polarizer film based on multilayer optical film includes alternating high and low refractive index layers. The skin layer of such multilayer optical films typically contains polymers such as PMMA, PC, etc. These types of multilayer optical films are one type of out-gassing substrates. Another issue with using an optical stack having an absorbing polarizer and a reflective polarizer in a display is the phenomena of micro-wrinkling which refers to a corrugation/bucking in the layers of the multilayer optical film. Such micro-wrinkling can occur during lamination of the optical stack to a component or can occur over time. For example, the optical stack may be used in an automobile application (e.g. a LCD display in an automobile) where the optical stack may be exposed to elevated temperatures which can lead to micro-wrinkling. Micro-wrinkling is characterized by adjacent surfaces or interfaces of the multilayer film not being parallel to each other. As described in PCT Appl. Publ. No. WO2017/205106 (Stover et al.) and corresponding U.S. patent application Ser. No. 16/301,106, for example, micro-wrinkling can be reduced by increasing the shrinkage of the reflective polarizer film to avoid compression stresses forming in the reflective polarizer film due to shrinkage of the absorbing polarizer when exposed to elevated temperatures.

In recent years, plastic panels such as PMMA, PCs, and cycloolefin polymers (COPs) have been used as touch panel modules, in particular, for automotive applications due to being lightweight, flexible, inexpensive, and safe. Both conventional cast molded articles and in-mold molded articles are used in touch panel modules having three-dimensional shapes. In cases where an OCA is used to bond a cover lens to a touch panel module that includes this type of plastic panel or molded article, both the cover lens and the plastic panel or molded article can be involved in the generation of outgas and the transmission of moisture vapor, and it can therefore difficult to prevent bubbling, peeling, clouding or white opacity in the touch panel. In addition, touch panels designed to be outdoors for long periods of time, such as automotive touch panels, require superior heat resistance and resistance to moist heat compared to conventional touch panels.

Many interesting and important studies have focused on improving the high temperature and high temperature/high humidity performance of PSAs. Example of such inventions are disclosed, for example, in U.S. Pat. No. 7,927,703B2 and US patent application 20170015877. Among those works, high glass transition temperature polymer additives of 5 wt % or more were disclosed to improve the high temperature performance.

One issue for a standard PSA is that its modulus falls sharply at elevated temperatures such that the PSA would behave similarly to high viscous liquids such that the mechanical properties of the PSA would not be preserved, and thus more mechanical failures could occur. While increasing cross-linking density can help to avoid this sharp fall of the modulus, the methods are very limited due to the loss of adhesion at room temperature.

### SUMMARY

In one embodiment, the present invention is a pressure sensitive adhesive including the reactive product of a copolymer of an alkyl(meth)acrylate, a multifunctional cross-linker, and at least one of an amine-containing (meth)acrylate and a blocked isocyanate-containing (meth)acrylate.

In another embodiment, the present invention is a laminate including a pressure sensitive adhesive having a first surface and a second surface, a polarizer positioned adjacent the first surface of the pressure sensitive adhesive, and a multilayer optical film positioned adjacent the second surface of the pressure sensitive adhesive. The pressure sensitive adhesive is a reactive product of a copolymer of an alkyl(meth)acrylate and a multifunctional cross-linker.

In yet another embodiment, the present invention is a laminate including a pressure sensitive adhesive having a first surface and a second surface, a polarizer positioned adjacent the first surface of the pressure sensitive adhesive, and a multilayer optical film positioned adjacent the second surface of the pressure sensitive adhesive. At a temperature of about 85° C., the pressure sensitive adhesive has a tan delta of less than about 0.4 and at a temperature of about 65° C., the pressure sensitive adhesive has a storage modulus of greater than about 60 KPa.

### DETAILED DESCRIPTION

The present invention is a pressure sensitive adhesive (PSA) having a high modulus/low tan delta at high temperatures while also retaining the beneficial properties of a typical PSA. The pressure sensitive adhesive of the present invention includes the reactive product of a copolymer of an alkyl(meth)acrylate, a multifunctional cross-linker, and at least one of an amine-containing (meth)acrylate and a blocked isocyanate-containing (meth)acrylate. It can generally be a challenge for PSAs to maintain high performance, such as adhesion and environmental durability, at high temperatures (typically greater than 60° C.) where the PSAs are transitioning to a viscous liquid state and the modulus of the PSA falls sharply. However, due to the increased high temperature modulus of the PSA of the present invention, the PSA of the present invention shows improved high temperature performance such as adhesion (i.e., high peel strength), out-gassing resistance, and bubble resistance without the similar mechanical properties exhibited at room temperature being affected. In addition, the PSA of the present invention can prevent micro-wrinkles and maintain good out-gassing performance. In one embodiment, the PSAs of the present invention are optically clear adhesives that can be used in applications involving electronic assemblies.

The pressure sensitive adhesive of the present invention includes the reaction product of a copolymer of an alkyl(meth)acrylate, a multifunctional cross-linker, at least one of an amine-containing (meth)acrylate and a blocked isocyanate-containing (meth)acrylate, and a photoinitiator. In one embodiment, the copolymer of an alkyl(meth)acrylate has unsaturated pendant groups. Generally, the copolymer of an alkyl(meth)acrylate has unsaturated pendant groups when the pressure sensitive adhesive includes an amine-containing (meth)acrylate,

In one embodiment, when the pressure sensitive adhesive includes a copolymer of an alkyl(meth)acrylate having unsaturated pendant groups and an amine-containing (meth)acrylate, the pressure sensitive adhesive includes between about 60 and about 95 wt % reactive product of a copolymer of an alkyl(meth)acrylate having unsaturated pendant groups, between about 1 and about 20 wt % multifunctional cross-linker, between about 0.1 and about 5 wt % amine-containing (meth)acrylate, and between about 0.1 and about 1 wt % photoinitiator. Particularly, the pressure sensitive adhesive includes between about 80 and about 95 wt % reactive product of a copolymer of an alkyl(meth)acrylate having unsaturated pendant groups, between about 3 and about 15 wt % multifunctional cross-linker, between about 1 and about 5 wt % amine-containing (meth)acrylate, and between about 0.1 and about 0.75 wt % photoinitiator. More particularly, the pressure sensitive adhesive includes between about 85 and about 95 wt % reactive product of a copolymer of an alkyl(meth)acrylate having unsaturated pendant groups, between about 5 and about 10 wt % multifunctional cross-linker, between about 1 and about 3 wt % amine-containing (meth)acrylate, and between about 0.2 and about 0.5 wt % photoinitator.

In one embodiment, when the pressure sensitive adhesive includes a blocked isocyanate-containing (meth)acrylate, the copolymer of an alkyl(meth)acrylate does not need to include unsaturated pendant groups. In one embodiment, when the pressure sensitive adhesive includes a blocked isocyanate-containing (meth)acrylate, the pressure sensitive adhesive includes between about 60 and about 95 wt % reactive product of a copolymer of an alkyl(meth)acrylate, between about 1 and about 20 wt % multifunctional cross-linker, between about 0.1 and about 3 wt % blocked isocyanate-containing (meth)acrylate, and between about 0.1 and about 1 wt % photoinitiator. Particularly, the pressure sensitive adhesive includes between about 80 and about 95 wt % reactive product of a copolymer of an alkyl(meth)acrylate, between about 3 and about 15 wt % multifunctional cross-linker, between about 1 and about 5 wt % blocked isocyanate-containing (meth)acrylate, and between about 0.1 and about 0.75 wt % photoinitiator. More particularly, the pressure sensitive adhesive includes between about 85 and about 95 wt % reactive product of a copolymer of an alkyl(meth)acrylate, between about 5 and about 10 wt % multifunctional cross-linker, between about 0.1 and about 1 wt % blocked isocyanate-containing (meth)acrylate, and between about 0.2 and about 0.5 wt % photoinitator

The reaction product of a copolymer of an alkyl(meth)acrylate having unsaturated pendant groups is a copolymer formed by firstly polymerizing a mixture of monomers including at least one (C₁-C₁₈)alkyl(meth)acrylate monomer, a polar (meth)acrylate monomer, and a hydroxy containing (meth)acrylate monomer. After polymerization, a portion of pendant hydroxyl groups are further converted to pendant unsaturated (meth)acrylate groups.

The base copolymer having unsaturated pendant groups was prepared through a two-step reaction. In the first step, suitable alkyl(meth)acrylate monomers, polar (meth)acrylate monomer, hydroxy-containing monomer are polymerized through a thermal process in solvents. Examples of suitable monomers that are made in a free radical copolymerization include, but are not limited to: 2-ethyl hexyl acrylate (2-EHA), 2-hydroxyethyl acrylate (HEA), acrylamide (ACM), butyl acrylate (BA), and 2-ethylhexyl methacry late (EHMA). Pentaerythritol tetrakis (3-mercaptobutanoate) (PE1) is an example of a suitable chain transfer agent for the copolymer to control molecular weights and 2-2-azobis (2,4 dimethylpentanenitrile) is an example of a thermal initiator for the polymerization. Examples of suitable solvents include, but not limited to: ethyl acetate, methyl ethyl ketone, etc.

In the second reaction step, unsaturated pendant groups are grafted through the reaction of isocyananatoethyl(meth)acrylate with hydroxy groups of the copolymer. The IEM creates the pendant unsaturated groups on the copolymer after thermal processing. An example of a commercially suitable isocyananatoethyl(meth)acrylate includes KarenzAOI™ (2-Isocyanatoethyl acrylate) and i KarenzMOI™ (2-Isocyanatoethyl methacrylate), available from Showa Denko, Toyko, Japan.

The base copolymer not having pendant unsaturated groups was prepared using suitable alkyl(meth)acrylate monomers, polar (meth)acrylate monomers, and hydroxy-containing monomers that are polymerized through a thermal process in solvents. Examples of suitable monomers that are made in a free radical copolymerization include, but are not limited to: 2-ethyl hexyl acrylate (2-EHA), 2-hydroxyethyl acrylate (HEA), acrylamide (ACM), butyl acrylate (BA), and 2-ethylhexyl methacrylate (EHMA). Pentaerythritol tetrakis (3-mercaptobutanoate) (PE1) is an example of a suitable chain transfer agent for the copolymer to control molecular weights and 2-2′-azobis(2,4 dimethylpentanenitrile) is an example of a thermal initiator for the polymerization. Examples of suitable solvents include, but are not limited to: ethyl acetate, methyl ethyl ketone, etc.

The cross-linker functions to bond the polymer chains together. Examples of suitable commercially available cross-linkers may include the following urethane acrylate oligomers, but are not limited to: CN983, CN965, CN966, CN9893, and CN996, available from Sartomer, Exton, PA and ETERCURE DR-U299, DR-U388, DR-U249, and DR-U282 available from Eternal Chemical, Kaohsiung, Taiwan.

The amine-containing (meth)acrylates and/or blocked isocyanate-containing (meth)acrylates can be incorporated in the adhesive material to co-react with both the multifunctional acrylate and acrylic copolymer with pendant (meth)acrylic side chains and/or hydroxy groups on the side chain of the acrylic copolymer to improve the mechanical strength of the fully cured adhesive. The addition of amine-containing (meth)acrylate and/or blocked isocyanate-containing (meth)acrylate in combination with urethane multiacrylate oligomers can increase the modulus of the pressure sensitive adhesive, particularly at higher temperatures. An example of a suitable amine-containing (meth)acrylate includes, but is not limited to, N-[3-(Dimethylamino)propyl]methacrylamide (DMAPMA). An example of a commercially suitable DMAPMA includes, but is not limited to, VISIONER® DMAMPA, available from Evonik, Germany. Examples of suitable commercially available blocked isocyanate-containing (meth)acrylates include, but are not limited to, KarenzMOI-BP and KarenzMOI-BM, available from Showa Denko K.K., Tokyo, Japan. The blocked isocyanate groups can be de-blocked with heat activation, and further react with acrylic copolymers through their pendant hydroxy groups to form cross-linking.

A photoinitiator is used to cure the pressure sensitive adhesive composition comprising the acrylic copolymer, the amine containing (meth)acrylate and/or blocked isocyanate-containing (meth)acrylate, and the multifunctional (meth)acrylate. Typically, the initiator or initiators are activated by exposure to light of the appropriate wavelength and intensity. In one embodiment, ultraviolet light is used. However, other methods may be used without departing from the intended scope of the present invention. Examples of suitable commercially available photoinitators include, but are not limited to: Omnirad 4265, Omnirad 184, Omnirad 819, Omnirad TPO, and Omnirad TPO-L, available from IGM Resins, located in Charlotte, NC. In one embodiment, the pressure sensitive adhesive includes between about 0.1 and about 1.5 wt % photoinitiator, particularly between about 0.1 and about 1 wt % photoinitiator, and more particularly between about 0.2 and about 0.6 wt % photoinitiator.

Other materials can be added to the precursor mixture for special purposes, including, for example: stabilizers, adhesion promoters, crosslinking agents, surface modifying agents, ultraviolet light stabilizers, antioxidants, antistatic agents, thickeners, fillers, pigments, colorants, dyes, thixotropic agents, processing aids, nanoparticles, fibers and combinations thereof.

A stabilizer can be included in the pressure sensitive adhesive to ensure some degree of long-term stability. An example of a suitable stabilizer includes, but is not limited to, butylated hydroxytoluene (BHT). BHT is a common phenolic antioxidant, having the role of donating hydrogen atoms to quench free radicals as well as to generate phenoxy groups which can obtain free radicals. They function as reagents which are consumed in order to protect the polymer/adhesive during its life cycle and/or repeated heat histories. In one embodiment, when the pressure sensitive adhesive includes a stabilizer, the pressure sensitive adhesive includes between about 0.01 and about 5 wt % stabilizer, particularly between about 0.1 and about 1 wt % stabilizer, and more particularly between about 0.1 and about 0.5 wt % stabilizer.

An adhesion promoter can be included to improve interfacial adhesion between the adhesive material and the adherend. An example of a suitable adhesion promoter includes, but is not limited to, glycidyloxypropyltrimethoxysilane (GPTMS). In one embodiment, when the pressure sensitive adhesive includes an adhesion promoter, the pressure sensitive adhesive includes between about 0.01 and about 5 wt % adhesion promoter, particularly between about 0.05 and about 1 wt % adhesion promoter, and more particularly between about 0.05 and about 0.5 wt % adhesion promoter.

The pressure sensitive adhesive of the present invention maintains optical clarity, bond strength, and resistance to delamination over the lifetime of the article in which it is used. As used herein, the term “optically clear” refers to a material that has a haze of less than about 6%, particularly less than about 4% and more particularly less than about 2%; a luminous transmission of greater than about 88%, particularly greater than about 89%, and more particularly greater than about 90%; and an optical clarity of greater than about 98%, particularly greater than about 99%, and more particularly greater than about 99.5% when cured. Typically, the clarity, haze, and transmission are measured on a construction in which the adhesive is held between two optical films, such as poly(ethylene terephthalate) (PET). The measurement is then taken on the entire construction, including the adhesive and the substrates. Both the haze and the luminous transmission can be determined using, for example, ASTM-D 1003-92. The optical measurements of transmission, haze, and optical clarity can be made using, for example, a BYK Gardner haze-gard plus 4725 instrument (Geretsried, Germany). The BYK instrument uses an illuminant “C” source and measures all the light over that spectral range to calculate a transmission value. Haze is the percentage of transmitted light that deviates from the incident beam by more than 2.5°. Optical clarity is evaluated at angles of less than 2.5°. Typically, the pressure sensitive adhesive is visually free of bubbles.

The pressure sensitive adhesive of the present invention exhibits a high modulus and a low tan delta at high temperatures. In one embodiment, the pressure sensitive adhesive has a tan delta of less than about 0.5, particularly less than about 0.4, and more particularly less than about 0.3 at a temperature of about 85° C. In one embodiment, the pressure sensitive adhesive has a storage modulus of greater than about 60 KPa, and particularly greater than about 65 KPa, at a temperature of about 65° C.

In practice, the PSA composition can be positioned between a first substrate and a second substrate to form a laminate. The laminate includes the first substrate having at least one major surface, the second substrate having at least one major surface and the composition positioned adjacent the major surfaces of the first and second substrates. In one embodiment, at least one of the first and second substrates is optically clear and may include, for example, an optical film or optically clear substrate.

The laminate including the PSA composition can be used in a display assembly. The display assembly can further include another substrate (e.g., permanently or temporarily attached to the PSA composition), another adhesive layer, or a combination thereof. As used herein, the term “adjacent” can be used to refer to two layers that are in direct contact or that are separated by one or more thin layers, such as primer or hard coating. Often, adjacent layers are in direct contact. Additionally, laminates are provided that include the PSA composition positioned between two substrates, wherein at least one of the substrates is an optical film. Optical films intentionally enhance, manipulate, control, maintain, transmit, reflect, refract, absorb, retard, or otherwise alter light that impinges upon a surface of the film. Films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Films for the provided laminates can also include retarder plates such as quarter-wave and half-wave phase retardation optical elements. Other optically clear films include anti-splinter films and electromagnetic interference filters.

In some embodiments, the resulting laminates can be optical elements or can be used to prepare optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, glazing (e.g., windows and windshields), screens or displays, cathode ray tubes, and reflectors.

Exemplary optically clear substrates include, but are not limited to: a display panel, such as liquid crystal display, an OLED display, a touch panel, electrowetting display or a cathode ray tube, a window or glazing, an optical component such as a reflector, polarizer, diffraction grating, mirror, or cover lens, another film such as a decorative film or another optical film.

Representative examples of optically clear substrates include glass and polymeric substrates including those that contain polycarbonates, polyesters (e.g., polyethylene terephthalates and polyethylene naphthalates), polyurethanes, poly(meth)acrylates (e.g., polymethyl methacrylates), polyvinyl alcohols, polyolefins such as polyethylenes, polypropylenes, and cellulose triacetates. Typically, cover lenses can be made of glass, polymethyl methacrylates, or polycarbonate.

In one embodiment, the pressure sensitive adhesive includes a first surface and a second surface and is positioned adjacent a polarizer at the first surface and a multilayer optical film positioned adjacent the second surface. In one embodiment, the multilayer optical film is a plastic.

In one embodiment, when the pressure sensitive adhesive of the present invention is positioned between a PET substrate and a PMMA substrate and made into a laminate, the laminate has substantially no bubbles after the laminate is placed in an environment of 85° C./85% humidity for 500 hours. In another embodiment, the laminate has substantially no bubbles and substantially no micro-wrinkles after the laminate is placed in an environment of 105° C. for 300 hours.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

### Materials

| | | Supplier |
|---|---|---|
| 2-EHA | 2-ethyl hexyl acrylate | BASF, Charlotte, |
| | | North Carolina |
| HEA | 2-hydroxyethyl acrylate | Osaka Organic |
| | | Chemical Co., JP |
| ACM | Acrylamide | Zibo Zhangdian |
| | | Oriental Chemical Co., |
| | | Ltd., Shangdong, |
| | | China |
| BA | Butyl acrylate | BASF, Charlotte, |
| | | North Carolina |
| VISIOMER ® | N-[3- | Evonik Industries, |
| DMAPMA | (Dimethylamino)propyl]methacrylamide | Essen, Germany |
| RF32N | Silicone coated PET liners | SKC Hass, Korea |
| RF02N | Silicone coated PET liners | SKC Hass, Korea |
| EHMA | 2-ethylhexyl methacrylate | Mitsubishi Chem. |
| | | Americas, North |
| | | Carolina |
| PE1 | Pentaerythritol tetrakis (3- | Showa Denko, Tokyo, |
| | mercaptobutanoate) | Japan |
| Vazo 52 | 2,2′-Azobis(2,4 dimethylpentanenitrile) | E.I. du Pont de |
| | | Nemours and |
| | | Company, Wilmington, |
| | | Delaware. |
| IEM | Isocyananatoethyl methacrylate, | Showa Denko; Tokyo, |
| | commercialized under tradename | Japan |
| | “Karenz ™ MOI” | |
| BHT | Butylated hydroxytoluene | Aldrich, St. Louis, MO |
| Omnirad 184 | 1-Hydroxycyclohexyl phenyl ketone | IGM Resins USA Inc., |
| | | Charlotte, North |
| | | Carolina |
| Omnirad TPO-L | Ethyl(2,4,6-Trimethylbenzoyl)-phenyl | IGM Resins USA Inc., |
| | phosphinate | Charlotte, North |
| | | Carolina |
| GPTMS | Glycidoxypropyltrimethoxysilane | Evonik Industries, |
| | | Essen, Germany |
| Karenz ® MOI-BP | 2-[(3,5- | Showa Denko, Tokyo, |
| | dimethylpyrazolyl)carboxyamino]ethyl | JP |
| | methacrylate | |
| CN983 | A difunctional polyester urethane | Sartomer, Exton, |
| | oligomer | Pennsylvania |
| CN996 | A difunctional polyester urethane | Sartomer, Exton, |
| | oligomer | Pennsylvania |
| DLRP Film | Multilayer optical film | 3M Company, St Paul, |
| | | MN |
| Polarizer | Sanritz 5518 absorbing polarizer | Sanritz Co., Ltd., Japan |

### Characterization/Equipment

Launderometer: the polymers were prepared by bottle polymerizations using an SDL Atlas Launder-ometer, model number M228AA.
IV: IV samples were dissolved in EtOAc at a concentration of 0.25 g/dL. A Lauda PVS Intrinsic Viscometer and a glass Cannon-Fenske Viscometer were used. The water bath temperature was 24 C.

### Preparation of Acrylic Copolymer A

To a 1 L amber bottle was added 2EHA (79.2 g), 2EHMA (22.0 g), BA (88.0 g), HEA (17.6 g), ACM (13.2 g), PE1 (0.46 g), and Vazo 52 (0.11 g). Ethyl acetate was added to the final composition to provide 55% solids (137.4 g). The components of the bottle were thoroughly degassed using nitrogen, then sealed. The reaction was conducted in a Launderometer at 60° C. for 5 hrs, then 65 C for 12 hrs. The final % solids was 54.7% with an IV of 0.73. A mixture of solvents was added to dilute it to 38% solids, including, ethyl acetate (33.0 g), MeOH (22.0 g), and 1 M2P (55.0 g).

### Preparation of Acrylic Copolymer B with Unsaturated Pendant Groups

To a 1 L amber bottle was added 2EHA (79.2 g), 2EHMA (22.0 g), BA (88.0 g), HEA (17.6 g), ACM (13.2 g), PEI (0.46 g), and Vazo 52 (0.11 g). Ethyl acetate was added to the final composition to provide 55% solids (137.4 g). The components of the bottle were thoroughly degassed using nitrogen, then sealed. The reaction was conducted in a Launderometer at 60° C. for 5 hrs, then 65 C for 12 hrs. The final % solids was 54.7% with an IV of 0.73. The polymer was then functionalized by purging with control gas and then adding BHT (0.22 g), IEM (0.22 g), and EtOAc (66.0 g), and mixing under a heat lamp set for 50 C for 24 hr. After 24 hrs, the mixture was cooled to room temperature and the polymer was diluted to 38% solids, including, Irgacure 184 (1.32 g), Irgacure TPO-L (0.44 g), GPTMS (0.22 g), ethyl acetate (33.0 g), MeOH (22.0 g), and 1 M2P (55.0 g).

### Test Method 1. Dynamic Mechanical Analysis

Dynamic mechanical analysis (DMA) was accomplished using an DHR3 PARALLEL PLATE RHEOMETER (TA Instruments) to characterize the physical properties of each sample as a function of temperature. For each sample, approximately 0.5 g of material was centered between 8 mm diameter parallel plates of the rheometer and compressed until the edges of the sample were uniform with the edges of the top and bottom plates. The furnace doors that surround the parallel plates and shafts of the rheometer were shut and the temperature was raised to 140° C. and held for 5 minutes. The temperature was then ramped from 120° C. to −20° C. at 3° C./min while the parallel plates were oscillated at a frequency of 1 Hz and a constant % strain of 0.4%. While many physical parameters of the material are recorded during the temperature ramp, storage modulus (G′), loss modulus (G″), and tan delta are of primary importance in the characterization of the homopolymers of this disclosure.

The glass transition temperature, Tg, of the adhesive composition can be measured by first determining its storage (G′) and loss shear moduli (G″). The ratio of G″/G′, a unit less parameter typically denoted “tan delta”, was plotted versus temperature. The maximum point (point where the slope was zero) in the transition region between the glassy region and the rubbery region of the tan delta curve (if well defined) determined the Tg of the adhesive composition at that particular frequency

### Testing Method 2: Accelerated Aging Test Method

Laminates were prepared by bonding a DLRP film and absorbing polarizer film using the OCA (25 μm thickness), and the polarizer was then laminated on LCD-glass. The full laminated samples were sent to autoclave (50 C, 5 Kg pressure, 20 min). Finally, the samples were aged in 105° C. oven for 24 hours, and 300 hours. Atter 24 hours, he laminates were taken out of the oven, cooled down to room temperature, and visually observed. Two type of failures were recorded, and they are micro-wrinkles and out-gassing bubbles.

### Testing Method 3: Accelerated Aging Test Method

Laminates were prepared by bonding a 50 micron PET films and PMMA film. The full laminated samples were sent to autoclave (50 C, 5 Kg pressure, 20 min). Finally, the samples were aged in 85° C./85% humidity oven for 500 hours. Then the laminates were taken out of the oven, cooled down to room temperature, and visually observed. Out-gassing bubble failures would be recorded.

### Microwrinkle and Out-Gassing Bubble Testing

The OCA sample of interest was laminated between the absorbing polarizer (a Sanritz 5518 absorbing polarizer) and 3M DLRP multilayer optical film, and then the absorbing polarizer was then laminated on LCD glass. The laminated samples were then placed in an oven set at 105° C. for 24 hours. After 24 hours, samples were removed from the oven, allowed to cool down to room temperature and inspected for micro-wrinkling and out-gassing bubbles. Micro-wrinkling was ranked at severe, slightly, and none three different levels. Out-gassing bubbles were ranked following the rating in Table 1 below.

TABLE 1

| | Number of bubbles per4 inch square sized |
|---|---|
| Out-gassing bubbles rating | samples |
| 5 | 0 |
| 4 | 1-2 bubbles |
| 3 | Less than 5 bubbles |
| 2 | 5-10 bubbles |
| 1 | More than 10 bubbles |

### Comparative Example 1: Preparation of OCA Using Base Adhesive Polymer

To a brown bottle, 120 g of 38% wt polymer solution A solution, 0.273 g of Irgacure 184, 0.09 g of TPO-L, 0.05 g of GPTMS, 3.648 g of CN983 (50% wt dispersed in MEK), and 1.824 g of CN996 (50% wt dispersed in MEK) were added. The bottle was placed on a roller for overnight mixing to form a homogenous adhesive coating solution.

### Comparative Example 2: Preparation of OCA Using Base Adhesive Polymer with Unsaturated Pendant Groups

To a brown bottle, 120 g of 38% wt polymer solution B, 0.273 g of Irgacure 184, 0.09 g of TPO-L, 0.05 g of GPTMS, 3.648 g of CN983 (50% wt dispersed in MEK), and 1.824 g of CN996 (50% wt dispersed in MEK) were added. The bottle was placed on a roller for overnight mixing to form a homogenous adhesive coating solution.

### Comparative Example 3: Preparation of Acrylic OCA with Added High Tg Polymer Having N,N-Dimethyl Amine Groups on the its Side Chains

The adhesive solution was prepared following the Example 1 of U.S. Pat. No. 7,927,703B2. The adhesive solution was 20% solid.

### Example 1: Preparation of OCA with Acrylic Copolymer with Unsaturated Pendant Groups and Amine-Contained Monomer

To a brown bottle, 0 g of 38% wt polymer solution B, 1.0 g of DMAPMA, 3.648 g of CN983 (50% wt dispersed in MEK), and 1.824 g of CN996 (50% wt dispersed in MEK) were added. The bottle was placed on a bottle roller for overnight mixing to form a homogenous adhesive coating solution.

### Example 2: Preparation of OCA with Acrylic Copolymer with Unsaturated Pendant Groups and Amine-Contained Monomer

To a brown bottle, 0 g of 38% wt polymer solution B, 2.27 g of DMAPMA, 3.648 g of CN983 (50% wt dispersed in MEK), and 1.824 g of CN996 (50% wt dispersed in MEK) were added. Finally, the bottle was placed on a roller for overnight mixing to form a homogenous adhesive coating solution.

### Example 3: Preparation of OCA with Base Adhesive Polymer and Karenz®MOI-BP

To a brown bottle, 240 g of 38% wt polymer (1575) solution, 0.15 g Karenz@MOI-BP, 0.546 g of Irgacure 184, 0.18 g of TPO-L, 0.1 g of GPTMS, 7.3 g of CN983 (50% wt dispersed in MEK), and 3.65 g of CN996 (50% wt dispersed in MEK) were added. The bottle was placed on a roller for overnight mixing to form a homogenous adhesive coating solution.

### Adhesive Film Preparations

The solutions from Comparative Examples 1-3 and Examples 1-3 were coated on a 75-micron thick release liner (RF32N) using a knife coater to control the wet-coating thickness. The coated samples were dried at room temp for 15 min, then they were transferred to 70° C. drying oven for additional 30 min. Then a 50-micron thick easy liner (RF02N) was laminated on top of dried adhesive coating to form a transfer tape. The dried thickness of the adhesive is about 1 mil or 6 mil.

### Results

The rheology of the adhesives are listed in Table 2. In Comparable Example 1, there was no un-saturated polymerizable group so the reactive oligomers were polymerized and physically mixed with the base adhesive polymer. While in Comparable Example 2, the adhesive polymer was grafted with saturated polymerizable pedant groups and after final polymerization, the reactive oligomers and adhesive polymer were chemically cross-linked together. In Examples 1 and 2, the adhesive polymer contained the polymerizable pedant groups, reactive oligomers, and amine-containing monomers all chemically cross-linked together.

TABLE 2

| | | G′ (Kpa) | | | | Tan (^{δ}) | | Tg |
|---|---|---|---|---|---|---|---|---|
| | | 25° | 50° | 65° | 85° | 25° | 85° | (° |
| | | C. | C. | C. | C. | C. | C. | C.) |
| Comp. | Polymer A | 214 | 85.3 | 57 | 34.2 | 0.618 | 0.507 | 0.2 |
| Exam- | | | | | | | | |
| ple 1 | | | | | | | | |
| Comp. | Polymer B | 243 | 82.8 | 57.9 | 38.2 | 0.596 | 0.411 | −2.5 |
| Exam- | | | | | | | | |
| ple 2 | | | | | | | | |
| Exam- | Polymer | 283 | 98.1 | 68.5 | 46.6 | 0.606 | 0.369 | 0.76 |
| ple 1 | B + 2% wt | | | | | | | |
| | DMAPMA | | | | | | | |
| Exam- | Polymer | 363 | 116 | 76.7 | 50.3 | 0.607 | 0.362 | 0.8 |
| ple 2 | B + 5% wt | | | | | | | |
| | DMAPMA | | | | | | | |

Table 2 shows that the rheology properties, such as G′, increased from Comparable Example 1 to Comparable Example 2, and then further increased with the addition of amine-containing monomers. At high temperatures, the tan delta of the examples decreased with the addition of amine-containing monomers.

### Out-Gassing Performance Test

Examples 1-3 coating solutions were diluted to 30% wt using the mixture solvent of MEK and ethyl acetate (1:1 ratio). The coating solutions were pumped (using a pressure pot) at a rate of 28.4cc/min into a 20.3 cm (8 inch) wide slot-type coating die. The slot-coating die uniformly distributed a 20 cm wide coating onto a multiple layer optical film (DLRP) at a speed of 10 feet/min. Next, the solvents were dried out through two of 10-feet long oven (oven temperature is set at 150 F for the first oven zone and 185° F. for the second oven zone). A 2 mil RF02N liner was laminated on top of the drying adhesive coating. Next, the adhesive coating was post-cured using a Fusion System Model I600 configured with a D-bulb (available from Fusion UV Systems, Gaithersburg MD). The adhesive thickness is controlled at 25 microns.

To make laminated parts, the easy liners were peeled off, and the DLRP film was applied on absorbing polarizer that was supplied with a 15-miron adhesive on the other side. The full film stack was then laminated on glass substrate. The full laminated samples were sent to autoclave (50° C., 5 Kg pressure, 20 min). Finally, the samples were aged in 105° C. oven for 24 hours, and 300 hours. The results are shown in Table 3 below.

TABLE 3

| | Comp. | Comp. | Comp. | | | |
|---|---|---|---|---|---|---|
| | Ex. 3 | Ex. 2 | Ex. 1 | Ex. 1 | Ex. 2 | Ex. 3 |
| Micro- | Severe | No | No | No | No | No |
| wrinkles | | | | | | |
| Out-gassing | 5 | 3 | 1 | 4 | 4 | 3 |
| Bubbles | | | | | | |
| Rating | | | | | | |

For the out-gassing resistant evaluation on PMMA, 6 mil thick OCAs were prepared between RF32N and RF02N. The easy liner was peeled off, the OCA was laminated on 2-mil PET films, and then the tight liner was peeled off, the OCA/PET was laminated on top of a PMMA sheet. The samples were transferred into an 85° C./85% humidity oven for 500 hours. The results are shown in Table 4 below.

TABLE 4

| | Out-gassing bubble rating on |
|---|---|
| | PMMA |
| Comparable Example | 1 |
| 1 | |
| Comparable Example | 4 |
| 2 | |
| Example 1 | 5 |
| Example 2 | 5 |

Although the present invention has been described with reference to preferred embodiments, workers skilled in the art will recognize that changes may be made in form and detail without departing from the spirit and scope of the invention.

What is claimed is:

1. A pressure sensitive adhesive comprising the reactive product of:
a copolymer of an alkyl(meth)acrylate;
a multifunctional cross-linker; and
at least one of an amine-containing (meth)acrylate and a blocked isocyanate-containing (meth)acrylate.

2. The pressure sensitive adhesive of claim 1, wherein the copolymer of an alkyl(meth)acrylate has unsaturated pendant groups.

3. The pressure sensitive adhesive of claim 1, wherein the pressure sensitive adhesive is optically clear.

4. The pressure sensitive adhesive of claim 1, wherein at a temperature of about 85° C., the pressure sensitive adhesive has a tan delta of less than about 0.4.

5. The pressure sensitive adhesive of claim 1, wherein at a temperature of about 65° C., the pressure sensitive adhesive has a storage modulus of greater than about 60 KPa.

6. The pressure sensitive adhesive of claim 1, wherein at a temperature of about 65° C., the pressure sensitive adhesive has a storage modulus of greater than about 65 KPa.

7. The pressure sensitive adhesive of claim 1, wherein when the pressure sensitive adhesive is positioned between a PET substrate and a PMMA substrate and made into a laminate, the laminate has substantially no bubbles after the laminate is placed in an environment of 85° C./85% humidity for 500 hours.

8. The pressure sensitive adhesive of claim 2, wherein the copolymer of an alkyl(meth)acrylate having unsaturated pendant groups formed is through the reaction of isocyananatoethyl(meth)acrylate with hydroxy groups of the copolymer.

9. A laminate comprising:
a pressure sensitive adhesive having a first surface and a second surface, wherein the pressure sensitive adhesive is a reactive product of:
a copolymer of an alkyl (meth) acrylate; and
a multifunctional cross-linker,
a polarizer positioned adjacent the first surface of the pressure sensitive adhesive; and
a multilayer optical film positioned adjacent the second surface of the pressure sensitive adhesive.

10. The laminate of claim 9, wherein the pressure sensitive adhesive is optically clear.

11. The laminate of claim 9, wherein at a temperature of about 85° C., the pressure sensitive adhesive has a tan delta of less than about 0.4.

12. The laminate of claim 9, wherein at a temperature of about 65° C., the pressure sensitive adhesive has a storage modulus of greater than about 60 KPa.

13. The laminate of claim 9, wherein the pressure sensitive adhesive further comprises at least one of an amine-containing (meth)acrylate and a blocked isocyanate-containing (meth)acrylate.

14. The laminate of claim 9, wherein copolymer of an alkyl(meth)acrylate has unsaturated pendant groups.

15. The laminate of claim 14, wherein the copolymer of an alkyl(meth)acrylate having unsaturated pendant groups is formed through the reaction of isocyananatoethyl(meth)acrylate with hydroxy groups of the copolymer.

16. The laminate of claim 9, wherein the laminate has substantially no bubbles and substantially no micro-wrinkles after the laminate is placed in an environment of 105° C. for 300 hours.

17. A laminate comprising:
a pressure sensitive adhesive having a first surface and a second surface, wherein at a temperature of about 85° C., the pressure sensitive adhesive has a tan delta of less than about 0.4 and wherein at a temperature of about 65° C., the pressure sensitive adhesive has a storage modulus of greater than about 60 KPa;
a polarizer positioned adjacent the first surface of the pressure sensitive adhesive; and
a multilayer optical film positioned adjacent the second surface of the pressure sensitive adhesive.

18. The laminate of claim 17, wherein the pressure sensitive adhesive is optically clear.

19. The laminate of claim 17, wherein the laminate has substantially no bubbles and substantially no micro-wrinkles after the laminate is placed in an environment of 85° C./85% humidity for 500 hours.

20. The laminate of claim 17, wherein the pressure sensitive adhesive is a reactive product of:
a copolymer of an alkyl(meth)acrylate;
a multifunctional cross-linker, and
at least one of an amine-containing (meth)acrylate and a blocked isocyanate-containing (meth)acrylate.
